(19) United States
(12) Patent Application Publication
(10) Pub. No.: US 2019/0200656 A1
(43) Pub. Date: Jul. 4, 2019

(54) COMPOSITIONS AND METHODS FOR AVOIDING, REDUCING, AND REVERSING UNDESIRABLE VISUAL AND OLFACTORY EFFECTS IN FOOD PRODUCTS

(71) Applicant: Chew, LLC, Boston, MA (US)

(72) Inventors: Sharat JONNALAGADDA, Belmont, MA (US); Adam MAXWELL, Watertown, MA (US); Leslie MORGRET, Westborough, MA (US); Niva CHAPA, El Espinar (ES)

(73) Assignee: Chew, LLC

(21) Appl. No.: 16/235,513

(22) Filed: Dec. 28, 2018

Related U.S. Application Data
(60) Provisional application No. 62/611,621, filed on Dec. 29, 2017.

(51) Int. Cl. A23L 15/00; A23L 29/00; A23L 27/00

(52) U.S. Cl. CPC A23L 15/30; A23L 29/015; A23L 29/035; A23L 27/84; A23V 2002/00; A23V 2200/044; A23V 2250/1588; A23V 2250/1612; A23V 2250/1642; A23V 2300/24; A23V 2200/15

(57) ABSTRACT

In one embodiment, a method for creating a food product is provided. The method may include providing a portion of egg base, the egg base including water and egg solids; providing a portion of cations; mixing the water, the egg solids, and the cation portion; and heating the mixture. The cation portion may include at least one of Zinc, Manganese, and Copper cations. In another embodiment, a food product is provided. The food product may include cooked egg; and Sulfur-containing salts of at least one of Zinc, Manganese, and Copper. The food product may contain between 0.25 and 10 mg of metal components of the Sulfur-containing salts per 0.967 g egg white solids and between 0.25 and 10 mg of metal components of the Sulfur-containing salts per 5.35 g egg yolk solids.

This application claims priority to, and incorporates herein in its entirety, U.S. Provisional Patent Ser. No. 62/611,621, filed Dec. 29, 2017.

### TECHNICAL FIELD

This disclosure relates to compositions and methods for avoiding, reducing, and reversing undesirable visual, olfactory, and flavor-related effects associated with the cooking and processing of certain foods. More particularly, this disclosure is related to reducing the formation of, or partially eliminating, Hydrogen Sulfide (H₂S) and/or Ferrous Sulfide (FeS) in Sulfur containing foods, such as eggs and vegetables of brassica family.

### BACKGROUND

Foods contain a diversity of compounds, which when subjected to processing conditions, may result in odors, colors, and flavors that can be deemed desirable or undesirable. Hydrogen Sulfide is one such compound that is commonly observed in processed Sulfur-containing foods such as eggs and vegetables of brassica family. While the presence of Hydrogen Sulfide at certain levels in a food may contribute to an expected, characteristic odor, high levels of Hydrogen Sulfide may cause an offensive odor. Ferrous Sulfide is another such compound that is commonly observed in processed Sulfur containing foods; it may cause undesirable discoloration.

Protein rich foods undergo changes in texture because of unfolding and hydrolysis of proteins when thermally treated. The unfolding of proteins results in some amino acid residues to be exposed and vulnerable to chemical reactions. For example, liquid eggs when thermally treated (e.g., 50° C. and above) for extended durations (e.g., 10 minutes and above) generate Hydrogen Sulfide and Ferrous Sulfide. Cysteine residues in egg whites contain thiol group compounds, which are known to release of Hydrogen Sulfide. An excessive presence of Hydrogen Sulfide is typically perceived as an undesirable rotten egg odor. Concurrently, prolonged thermal treatments of whole eggs (liquid) leads to the formation of Ferrous Sulfide because of the reaction between Hydrogen Sulfide and the Iron (Fe) present in egg yolk. For example, Ferrous Sulfide is formed on the outer layer of yolk in hard-boiled eggs. In scenarios where liquid eggs are homogenized and thermally treated in a package, the occurrence of Ferrous Sulfide leads to an otherwise grayish-green discoloration.

Likewise in other foods, for example vegetable matter from brassica plants, Sulfur-based volatile compounds are responsible for their characteristic aroma. For example, in kale, enzymatic action following processing such as blanching, dehydration, pasteurization, slicing, and juicing results in formation of a variety of Sulfur-based volatiles that are not characteristic of fresh kale and perceived as undesirable, depending on the extent of nature of the processing. For example, beyond Hydrogen Sulfide and Ferrous Sulfide, it has been studied that Sulfur containing volatiles such as Dimethyl Disulfide, Dimethyl Trisulfide, Dimethyl Tetrasulfide, and Allyl Isothiocyanate may be generated depending on the type of vegetable and means of processing. Additionally, during such processes, chlorophyll may be converted to Pheophytin and/or Pyropheophytin resulting in discoloration of the vegetable, which may be characterized, for example by a brownish, greyish, or otherwise burnt-looking shade of green.

### SUMMARY

The present disclosure provides a description of compositions and methods to address the perceived problems described above.

In one embodiment, a method for creating a food product is provided. The method may include providing a portion of egg base, the egg base including water and egg solids; providing a portion of cations; mixing the water, the egg solids, and the cation portion; and heating the mixture. The cation portion may include at least one of Zinc, Manganese, and Copper cations.

The step of providing a portion of cations may further include providing between 0.25 and 10 mg of cations per quantity of egg base having Sulfur content equivalent to that of 10 g of whole liquid egg.

The step of providing a portion of cations may further include providing a mineral blend comprising at least two of Zinc, Manganese, and Copper cations at between 1 and 10 mg of total cations per quantity of egg base having Sulfur content equivalent to that of 10 g of whole liquid egg.

The step of providing a portion of cations may further include providing between 0.25 mg and 1 mg of Copper cations or between 0.25 mg and 2 mg of Copper cations per quantity of egg base having Sulfur content equivalent to that of 10 g of whole liquid egg. The step of providing Copper cations may include providing Copper Gluconate containing a corresponding amount of Copper.

The step of providing a portion of cations may further include providing a total of between 3 mg and 10 mg of Zinc and Manganese cations with a relative ratio of Zinc cations to Manganese cations of between 1:1 and 4:1 per quantity of egg base having Sulfur content equivalent to that of 10 g of whole liquid egg. The step of providing Zinc and Manganese cations may further include providing Zinc Gluconate containing a corresponding amount of Zinc cations and Manganese Gluconate containing a corresponding amount of Manganese cations. The step of providing Zinc and Manganese cations may further include providing less than 2 mg of Manganese cations per quantity of egg base having Sulfur content equivalent to that of 10 g of whole liquid egg. The step of providing Zinc and Manganese cations may further include providing Zinc Gluconate containing a corresponding amount of Zinc cations and Manganese Gluconate containing a corresponding amount of Manganese cations.

The step of providing a portion of cations may further include providing between 1 mg and 10 mg of Zinc cations per quantity of egg base having Sulfur content equivalent to that of 10 g of whole liquid egg. The step of providing Zinc cations may further include providing Zinc Gluconate containing a corresponding amount of Zinc cations. The step of providing Zinc cations may further include providing Zinc Gluconate containing a corresponding amount of Zinc cations.

The step of providing a portion of cations may further include providing between 1 mg and 5 mg of Zinc cations per quantity of egg base having Sulfur content equivalent to that of 10 g of whole liquid egg.

The step of heating the mixture may further include heating the mixture for at least ten minutes at a temperature of at least 50° C.

The step of providing a portion of cations may further include providing at least one of Zinc Gluconate, Manganese Gluconate, and Copper Gluconate.

In another embodiment, a food product is provided. The food product may include cooked egg; and Sulfur-containing salts of at least one of Zinc, Manganese, and Copper. The food product may contain between 0.25 and 10 mg of metal components of the Sulfur-containing salts per 0.967 g egg white solids and between 0.25 and 10 mg of metal components of the Sulfur-containing salts per 5.35 g egg yolk solids.

The Sulfur-containing salts may include Zinc Sulfide. The food product may contain between 1 and 10 mg of Zinc per 0.967 g egg white solids and between 1 and 10 mg of Zinc per 5.35 g egg yolk solids.

The Sulfur-containing salts may include Copper Sulfide and Copper Sulfate. The food product may contain between 0.25 and 2 mg of Copper per 0.967 g egg white solids and between 0.25 and 2 mg of Copper per 5.35 g egg yolk solids.

The cooked egg may include cooked egg yolk. And the food product may lack have a green-grey appearance.

In yet another embodiment, a food product is provided. The food product may be prepared by providing a portion of egg base, the egg base including water and egg solids; providing a portion of cations; mixing the water, the egg solids, and the cation portion; and heating the mixture. The cation portion may include at least one of Zinc, Manganese, and Copper cations.

### BRIEF DESCRIPTION OF THE DRAWINGS

The accompanying drawings, which are incorporated into and constitute a part of this disclosure, illustrate several embodiments and aspects of the foods, systems, and methods described herein and, together with the description, serve to explain the principles of the invention.

The patent or application file contains at least one drawing executed in color. Copies of this patent or patent application publication with color drawing(s) will be provided by the Office upon request and payment of the necessary fee.

FIG. 1A is a photo of laboratory results depicting Lead Acetate test strips indicative of volatile Sulfur-containing compounds resulting from egg products with various salts added at a concentration of 20 mg of cation/10 g of whole liquid egg, in accordance with exemplary embodiments.

FIG. 1B is a chart of laboratory results depicting subjective sensory data of cooked eggs with minerals and ascorbic acid added, with 1 indicating no off odor and 10 indicating the most off odor, in accordance with exemplary embodiments.

FIG. 2A is a photo of laboratory results depicting the color of samples of cooked egg with various salts and ascorbic acid, in accordance with exemplary embodiments.

FIG. 2B is a photo of laboratory results depicting the color of an exposed top surface of the samples depicted in FIG. 2A, in accordance with exemplary embodiments.

FIG. 2C is a chart of CIELAB color coordinates corresponding to the observed colors of samples depicted in FIGS. 2A and 2B, in accordance with exemplary embodiments.

FIG. 3 is a photo of laboratory results depicting Lead Acetate test strips indicative of volatile Sulfur-containing compounds resulting from kale preparations with various salts added at a concentration of 5 mg of cation/2 g of dried kale, in accordance with exemplary embodiments.

FIG. 4 is a photo of laboratory results depicting the colors of kale preparations treated with Zinc and Copper at a concentration of 5 mg of cation/2 g of dried kale, and then heated, in accordance with exemplary embodiments.

FIG. 5A is a chart of laboratory results showing measures of volatile Sulfur-containing compounds and egg surface color resulting from the inclusion of various amounts of Zinc, Copper, or Manganese in a liquid egg preparation, in accordance with exemplary embodiments.

FIG. 5B is a chart of laboratory results showing measures of volatile Sulfur-containing compounds and egg surface color resulting from the inclusion of various amounts of mineral blends comprising Zinc and Manganese salts in a liquid egg preparation, in accordance with exemplary embodiments.

FIG. 5C is a chart of laboratory results showing measures of volatile Sulfur-containing compounds and egg surface color resulting from the inclusion of various amounts of mineral blends comprising Zinc and Copper salts in a liquid egg preparation, in accordance with exemplary embodiments.

FIG. 5D is a chart of laboratory results showing measures of volatile Sulfur-containing compounds resulting from the inclusion of Zinc or Copper in liquid egg preparations with various egg yolk to egg white ratios, in accordance with exemplary embodiments.

FIG. 6 is a chart of laboratory results showing measures of volatile Sulfur-containing compounds and color resulting from the inclusion of various amounts of mineral blends comprising Zinc and Copper salts in a liquid kale preparation, in accordance with exemplary embodiments.

### DETAILED DESCRIPTION

In a non-limiting example, a blend of salts (or a single salt) containing metal ions such as Zinc, Copper, Manganese, with their anions being Gluconates is disclosed as a novel solution to address issues of undesirable visual and/or olfactory effects in certain food products. In alternative embodiments, the salt(s) may comprise anions of one or more of ions of elements such as Oxygen, Nitrogen, Phosphorus, Iodine, Chlorine, Fluorine, Hydrogen, Bromine and those of organic variety such as Citrate, Ascorbate, Maleate, Benzoate, Acetate, Orotate, Fumarate, Lactate, Picolinate, Glycerate, and Monomethionine. Although this disclosure substantially refers to Gluconate salts, its teachings are equally applicable to salts with the referenced cations and alternative anions and/or solutions on the referenced cations. Such salts and solutions shall be considered disclosed herein.

In preferred embodiments, the ratio of respective metal ions to one another within the blend, and collectively to the food product or ingredient(s) being treated, may vary depending on the food system, processing conditions, and desired result. The dissolved cations in aqueous solutions may bind anions responsible for evolution of a family of off-flavor compounds, and, in particular, compounds containing Sulfur. The metal ions may also prevent the formation of grayish-green discoloration in prolonged cooking of liquid eggs and containing products. The metal ions may also improve the flavor and color of processed vegetable products with high chlorophyll content, such as those in the brassicaceae family, for example, kale and broccoli.

It is contemplated that the compositions and techniques disclosed herein may be applied across multiple technologies of food manufacture including, but not limited to, extrusion, retorting, HTST (High Temperature/Short Time processing), UHT (Ultra-high temperature processing), and pasteurization of a wide varied of egg-based and vegetable-based products, including soups and beverages that are high in brassica vegetables. Such disclosures may also be applied in various food systems, for example, in pet foods where protein denaturation is the major driver of product characteristics, such as flavor, as pets are extremely sensitive to off-flavors.

### Egg-Related Embodiments

Hydrogen Sulfide is known to be generated in cooked eggs, for example, as a result of oxidation of sulfhydryl and disulfide groups, particularly where such groups involve cysteine fragments. Stale eggs tend to be alkaline, and the evolution of Hydrogen Sulfide is slightly higher under such conditions. At an elevated pH, the reactivity of Sulfur in egg whites is further increased. The release of Hydrogen Sulfide is also dependent on the maximum temperature and duration of the heating process. Although Hydrogen Sulfide is also produced by the action of enzymes naturally present in eggs, such as Cysteine Lyase, the scale of Hydrogen Sulfide release resulting from enzymatic action is significantly less than that of non-enzymatic pathways, such as heat-based denaturing of egg whites.

Salts of Zinc, Copper, and Manganese, such as Gluconates, may be used to chelate Sulfur, preventing or reducing the complex process of Hydrogen Sulfide release from reactions such as oxidation and protein denaturation. In certain preferred embodiments, a blend of such salts of cation may be used, but use of a single salt or cation is also contemplated and may be preferred in some circumstances. Zn, Cu, and Mn have been observed to have strong affinity for Sulfur and are capable of competitively displacing Hydrogen as a cation in reactions involving Sulfur. Addition of such salts to liquid eggs or aqueous solutions of egg white and/or egg yolk powders has been discovered to reduce undesirable odors.

In preferred embodiments, the salt blend may be applied by mixing it with raw egg (or equivalent) prior to heating or cooking. However, it is contemplated that cooked egg may be treated with disclosed salt preparations to beneficial use, notwithstanding that such treatment may require breaking a coagulated egg matrix into an aqueous solution or the like.

For whole liquid eggs or hydrated forms of egg with any ratio of yolk to egg white, certain embodiments may utilize a mineral blend comprising of Zinc, Manganese, and Copper cations at ratios ranging from 4:1 to 1:1 for Zn:Mn or Zn:Cu. Such ratios may reflect the effects of the respective cations as to both odor and color, and may further reflect a nutrition-based avoidance of adding too much (e.g., as indicated by the Recommended Dietary Allowance) of any particular metal cation to the human diet. The collective amount of cations added to each 10 g of whole liquid egg for off-scent and/or discoloration reduction preferably ranges from 0.25 mg to 10 mg or from 1 mg to 10 mg. It is to be understood that although some minimal amount of water is required to support the requisite chemical reactions, the various ratios of cations to each other and egg solids shall generally otherwise be unaffected by the amount of water.

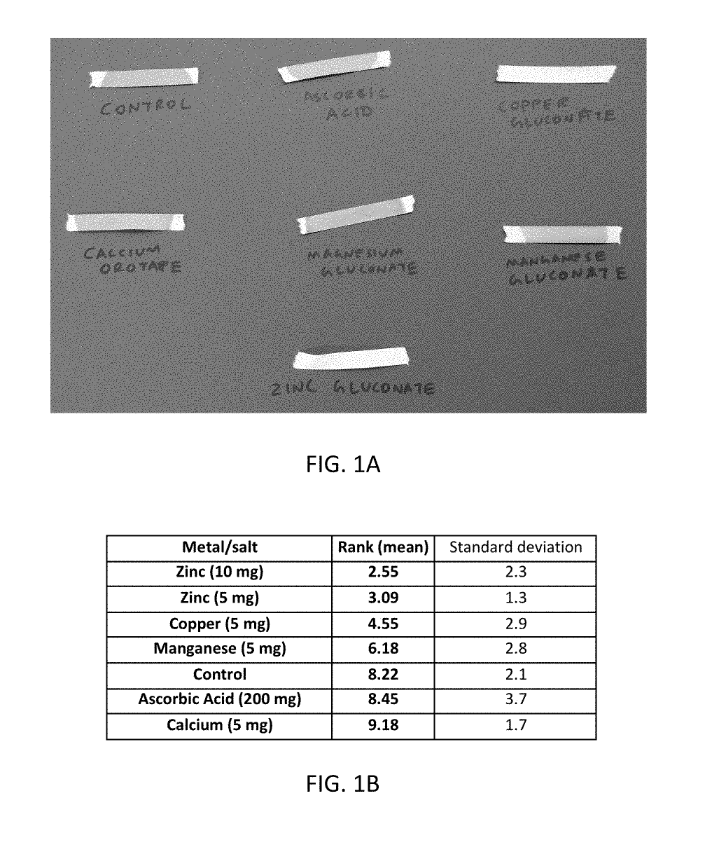

To arrive at preferred embodiments, mineral salts such as Zinc Gluconate, Copper Gluconate, Calcium Orotate, Manganese Gluconate, and Magnesium Gluconate were selected based on the electropositivity of cation compared to Iron. These salts were tested at levels of 20 mg of cation for every 10 g of whole egg in a glass jar for Hydrogen Sulfide production during heating, which was at 95° C. for 30 minutes. Lead acetate test paper was used for detecting the release of Hydrogen Sulfide. Each test strip was stuck to the top of glass jars without touching the solution being heated. Because Lead Acetate interacts with Hydrogen Sulfide to result in Lead Sulfide—a dark gray-black substance, the extent of darkening of each test strip is indicates the relative concentration of Hydrogen Sulfide or other volatile Sulfur-containing compounds in the headspace of glass jars. As shown in FIG. 1, a visual comparison of Lead Acetate test paper demonstrated that Zinc and Copper at these concentrations were effective at completely chelating Sulfur, while Manganese was effective to a lesser degree. The remaining salts yielded a similar darkening of test paper compared as the control, where no salts were added.

To subjectively test the effectiveness of various salts of at reducing offensive odors, ten panelists were selected to perform sensory evaluation of samples of 10 g of eggs cooked in a glass jar at 95° C. for 30 minutes, with mineral salts and ascorbic acid respectively added prior to cooking. It was determined that the addition of Zinc Gluconate at levels of 10 mg and 5 mg of Zinc scored the lowest in off-odor development, followed by Copper and Manganese. FIG. 1B provides the amounts of additives in each sample and the results of sensory data. The sample with ascorbic acid at 200 mg and calcium orotate with calcium at 5 mg scored higher than control in off odor development.

Additionally, salts containing metal ions such as Zinc, Copper, and/or Manganese may also prevent gray-green discoloration in eggs.

The release of Hydrogen Sulfide during heating of eggs has been closely linked with the formation of green-gray discolored product. Egg yolk has 85 times more Iron than egg whites and during prolonged heating above temperatures exceeding 60° C., Iron interacts with Hydrogen Sulfide to yield Ferrous Sulfide by competitively displacing Hydrogen. As is known in the art, compounds such as citric acid, ascorbic acid, and EDTA may to chelate Iron in order to prevent discoloration of cooked liquid eggs. However, as disclosed herein, it has been advantageously discovered that blends of Zinc, Copper, and/or Manganese Gluconates to bind Sulfur and make it unavailable for Fe2+ ion to act on. It is believed that cations of Zinc, Copper, and/or Manganese are capable of preventing or reducing Ferrous Sulfide production in cooked egg whites in two ways: (i) preventing or reduce the release of Hydrogen Sulfide; and (ii) competitive displacement of Iron from Iron Sulfide.

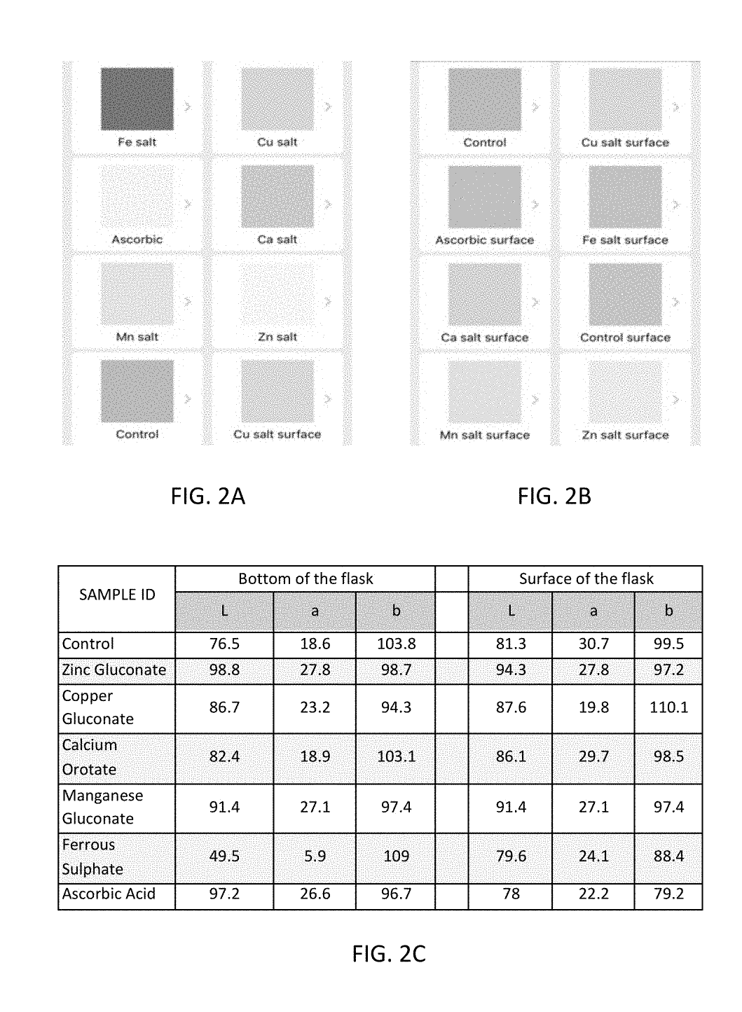

To test the effectiveness of cation additions in improving visual characteristics of cooked eggs, 5 mg of each cation was added to 10 g of whole egg and heated to 95° C. for 1 hour. As a control, 200 mg of ascorbic acid was added to one 10 g whole egg sample. As shown in FIGS. 2A and 2B, the results indicated that the addition of Zinc cations completely avoided the characteristic grey or green-grey color obtained after exceeding heating in hard boiled eggs, giving an appearance of fresh and fairly cooked egg. Ascorbic acid is known as a chelator of Iron and was tested similarly for comparison. While most of the egg cooked with ascorbic acid looked yellow, there was a still a brown discoloration at the surface of the cooked egg, which may be associated with production of Ferrous ascorbate. It is believed that use of Copper Gluconate resulted in the production of Copper Sulfate, which like Ferrous Sulfide, is a salt with an undesired color. Manganese was the only other salt that yielded a color comparable to cooked egg besides Zinc. As shown in FIG. 2C, objective color data in CIELAB color coordinates was acquired with the use of Nix™ Pro Color Sensor.

It may be noted that the surface of each cooked egg sample (FIG. 2B) is different than the bottom of each sample (FIG. 2A), which corresponds to the internal color of each sample. The internal sample color is indicative of the discoloration (if any) resulting from the presence of Ferrous Sulfide.

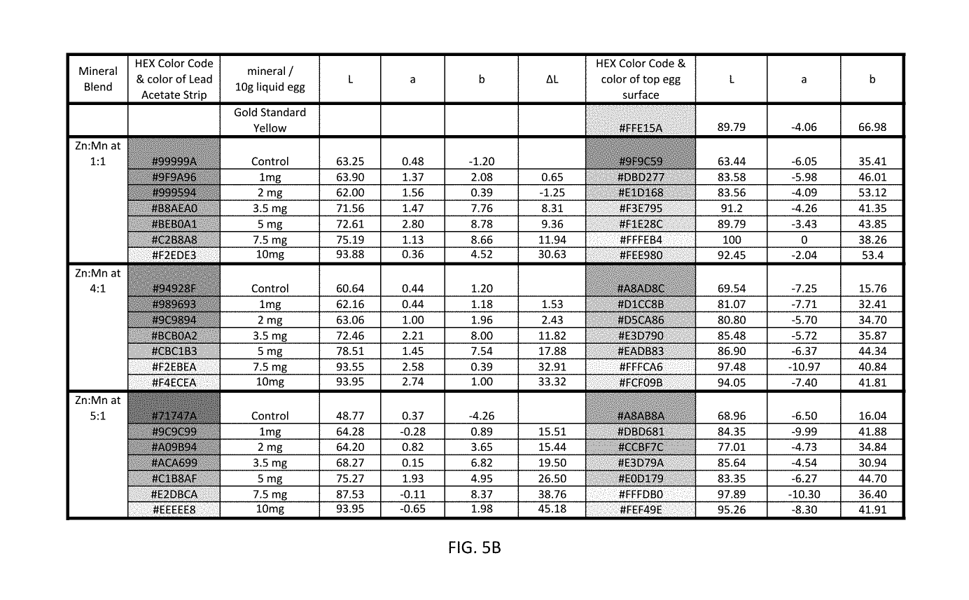

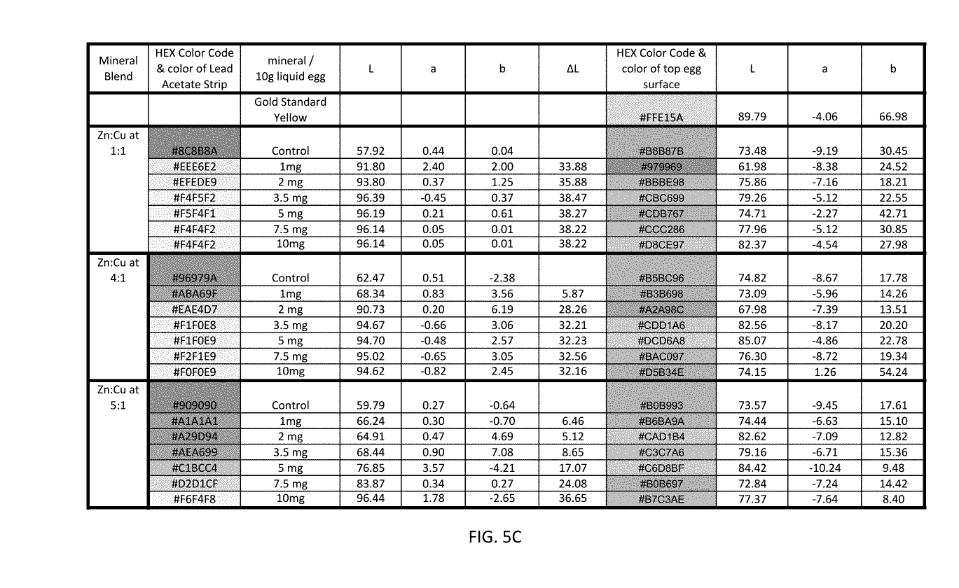

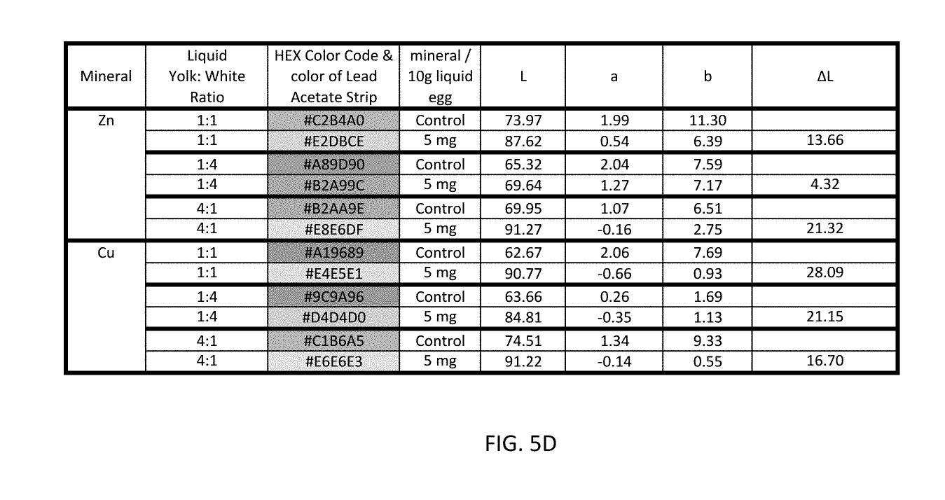

FIGS. 5A-5C depict lab results showing measures of volatile Sulfur-containing compounds and egg surface color resulting from the inclusion of various amounts of minerals and mineral blends in a liquid egg preparation. For each tested sample, 10 g of whole liquid egg was mixed with the listed mineral or mineral blend in Gluconate salt form. The amount of mineral represents to the weight of mineral cations (in mg) included in each sample. For example, for each mg of Zinc, 6.97 mg of Zinc Gluconate was included; for each mg of Copper, 7.14 mg of Copper Gluconate was included; and, for each mg of Manganese, 8.1 mg of Manganese Gluconate was included.

Each whole liquid egg and salt mixture was transferred to a glass bottle with a metal screw cap capable of sustaining pressures generated from vapor evolution during the process of cooking. A Lead Acetate strip of 100 mm×7 mm was placed on top of the opening of glass bottle before the metal cap is screwed in so that the strip did not in contact with the eggs, but was exposed to gases generated in the headspace of the bottle during cooking. The bottles are then placed in a hot water bath at 100 C and then removed after one hour. Such cooking process may be understood to simulate retort.

As discussed above, the color of the Lead Acetate strips is indicative of the release of volatile Sulfur-containing compounds. In addition to depicting the resulting color of each strip, FIGS. 5A-5C recite the resulting color in the form of both HEX Color code and in CIELAB color coordinates. The ΔL in CIELAB coordinates, as calculated from the control strip (no mineral added) represents the lightening of each strip compared to control. ΔL is indicative of the effectiveness of each mineral or mineral blend addition. ΔL below 10 may be understood to indicate an ineffective reduction in release of volatile Sulfur-containing compounds. ΔL at or above 10 may be understood to indicate an effective reduction in release of volatile Sulfur-containing compounds. ΔL at or above 15 may be understood to indicate a very effective reduction in release of volatile Sulfur-containing compounds. ΔL at or above 25 may be understood to indicate an exceptionally effective reduction in release of volatile Sulfur-containing compounds. Lead acetate strips from Whatman, GE Healthcare Life Sciences, Buckinghamshire, UK were utilized so comparable ΔL may be expected when testing is repeated with the same or substantially similar strips.

FIGS. 5A-5C also depict the resulting color of the top surface cooked egg samples; such color is also described in the form of both HEX Color code and in CIELAB color coordinates. For comparative purposes, a “gold standard yellow,” where approximates an ideal cooked egg color is provided; such color is also described in the form of both HEX Color code and in CIELAB color coordinates. The gold standard yellow was acquired by boiling 10 g of whole liquid eggs in an enclosed glass container for 2 minutes. Such cooking did not result in an undesirable green-grey color because Ferrous Sulfide formation during such a short cooking period is significantly lower when compared to eggs subjected to prolonged cooking.

As may be readily observed from FIG. 5A, Zinc was much more effective at reducing gray-green discoloration from Ferrous Sulfide formation than reduction of volatile Sulfur-containing compounds. Still, Zinc was very effective at reducing the release of volatile Sulfur-containing compounds at all tested concentrations, and was exceptionally effective beginning at concentrations around 7.5 mg/10 g egg. Zinc's sequestration of sulfur results in the formation of sulfur-containing Zinc salts in the cooked egg products, which may be understood to contain substantially all of the added Zinc cations. Zinc Sulfide (ZnS), often characterized by a white color, may be understood to be the dominant Sulfur-containing Zinc salt formed.

Copper was exceptionally effective at reducing the release of volatile Sulfur-containing compounds at all tested concentrations. Indeed, increases in the amount of Copper beyond 1 mg/10 g egg offered no or negligible improvement. Indeed, it is expected that the addition of Copper cations in amounts as low as at 0.25 mg/10 g whole liquid egg, and perhaps even lower, is likely to be effective at reducing the release of volatile Sulfur-containing compounds. Copper's sequestration of sulfur results in the formation of Sulfur-containing Copper salts in the cooked egg products, which may be understood to contain substantially all of the added Copper cations.

However, it may be readily observed that the resulting color of Copper-treated eggs is generally undesirable, and may be characterized as containing blue, bluish-grey, red, brown, and/or green hues. Aesthetically, such results may be viewed by a consumer as even worse than the typical grey-green discoloration of eggs because such colorations do not appear natural. It is believed that this undesirable color effect is caused by the diversity of Sulfurous compounds that may result for the Copper's sequestration of Sulfur, including, for example, Copper Sulfate (CuSO4), and Copper Sulfides (CuS, Cu₂S). Thus, the addition of Copper to eggs or egg-containing products may be desirable to control odors. It may be added, for example, in circumstances where the color may be hidden from the consumer, for example by other ingredients.

Manganese was ineffective at reducing the release of volatile Sulfur-containing compounds at all tested concentrations. It was, however, effective in improving egg surface color, especially at the higher end of the tested range. Manganese's sequestration of sulfur results in the formation of sulfur-containing Manganese salts in the cooked egg products, which may be understood to contain substantially all of the added Manganese cations. Manganese Sulfide (MnS), may be understood to be the dominant Sulfur-containing Manganese salt formed.

It is known in the art that tolerable upper limits of Zinc, Copper, and Manganese for adults are approximately 40 mg/day, 10 mg/day, and 11 mg/day, respectively. Moreover, such limits are substantially lower for children. Give that an egg typically weighs approximately 40 g; that people commonly eat two or more eggs in a day; and that people may ingest minerals in other foods, it is desirable to avoid using excessive amounts of Copper and Manganese—and to a lesser extent, Zinc—in any food preparations. Accordingly, it has been discovered that using mineral blends of Zinc, Copper, and Manganese may be effective in reducing negative effects of Sulfur content at lower levels of mineral additions, and in some cases with improved effects. Embodiments that include less than 2 mg/10 g whole liquid egg—or less than 1 mg/10 g whole liquid egg—of Copper or Manganese may be preferred. Embodiments that include less than 10 mg/10 g whole liquid egg—or less than 5 mg/10 g whole liquid egg—of Zinc may be preferred.

FIG. 5B shows the results from the inclusion of various amounts of mineral blends of Zinc and Manganese at ratios of 1:1, 4:1, and 5:1. As may be observed, the egg surface color at Zinc and Manganese ratios of 1:1 and, to a lesser extent, 4:1, more closely resemble the gold standard yellow then when Zinc is used alone. At the 5:1 ratio, the results appear to closely track those of Zinc alone. While off-color development in cooked liquid eggs is substantially reduced with mineral blend containing Zinc and Manganese at a ratio ranging from 1:4 to 4:1 at a concentration of 2 to 10 mg/10 g egg, ratios containing more Manganese than Zinc may be less desirable because of the upper limits for Manganese consumption and/or because of the negligible effect that Manganese may have on volatile Sulfur compound reduction. Thus, in certain embodiments a mineral blend containing Zinc and Manganese at a ratio ranging from 1:1 to 4:1 may be used, with preference given, for example, based on the degree of volatile Sulfur compound reduction.

FIG. 5C shows the results from the inclusion of various amounts of mineral blends of Zinc and Copper at ratios of 1:1, 4:1, and 5:1. As may be observed, the egg surface color among all samples is not desirable. Ratios containing more Copper than Zinc may be less desirable because of the upper limits for Copper consumption and because the egg surface color is likely to further worsen. Generally, volatile Sulfur compound reduction was effective at all ratios. However, with increasing amounts of Zinc in the blend, the benefit of Copper being present in the blend progressively decreases. The 5:1 blend demonstrates it is not that different from Zinc in preventing off odor development.

In some food products, differing ratios of egg yolk to egg white may be desired. The person of ordinary skill in the art would understand how to vary the amount mineral content added per amount liquid egg to account for Sulfur content in various yolk to egg ratios using well known principles of stoichiometry. As a guide, 100 g of whole liquid egg contains 34 g of egg yolk to 66 g of egg white; 100 g egg white contains 182.5 mg of Sulfur; and 100 g egg yolk contains 164.5 mg of Sulfur. Thus, 100 g whole liquid egg contains 55.93 mg Sulfur coming from yolk and 120.45 mg Sulfur coming from egg white, yielding 176.4 mg of Sulfur total. In turn, 10 g whole liquid egg contains 17.6 mg Sulfur total.

Similarly, some food products are created using dried egg solids, which may be hydrated to create liquid egg. Moreover, the amount of egg white solids and egg yolk solids in liquid egg and cooked egg may be measured via known techniques. The person of ordinary skill in the art would also understand how to vary the amount minerals content added per amount of egg solids to account for Sulfur content in various amounts of egg white solids and egg yolk solids using well known principles of stoichiometry. As a guide, 10 g of whole liquid eggs contains 2.4 g of solids, comprising 0.66 g of egg white solids and 1.74 g of egg yolk solids; dry egg white contains 1825 mg of Sulfur/100 g; and dry egg yolk contains 330 mg/100 g. Accordingly, 0.967 g dry egg white contains 17.64 mg Sulfur, the amount in 10 g whole liquid egg; and 5.35 g dry egg white contains 17.64 mg Sulfur. It is contemplated that the techniques disclosed herein may be applied to improve egg white only products, egg yolk only products, and products at any of the various ratios in between. This holds true for products created from liquid egg or egg components, dry egg or egg components, and combinations thereof.

In some embodiments, dry egg white and/or egg yolk may be mixed with minerals salts discussed herein to provide an improved dry egg mixture that automatically treats undesirable olfactory and/or color properties when it is later hydrated into liquid egg and heated.

FIG. 5D depicts lab results showing measures of volatile Sulfur-containing compounds resulting from the inclusion of various amounts of 0 mg (control) and 5 mg of Zinc and Copper, respectively, in various liquid egg preparations. In addition to depicting the resulting color of each strip, FIG. 5D recites the resulting color in the form of both HEX Color code and in CIELAB color coordinates. The egg preparations represent various ratios of liquid egg yolk to liquid egg white. Each was prepared using 2.4 g of total dry egg powder in a ratio suitable to achieve the recited liquid yolk: white ratios, 7.6 g of water, and an amount of Gluconate salt to arrive at the listed mineral content (if any). The mixtures were cooked in the manner described above with respect to FIGS. 5A-5C.

### Vegetable-Related Embodiments

Zinc and Copper salts, such as Gluconates, may reduce off-flavor and undesirable odor development in brassica vegetables during processing. Such mineral blends may improve the flavor of processed vegetable products containing Sulfurous compounds. The mineral blend may vary in ratio of respective metal salts to one another within the blend, as well as collectively to the food product or ingredient(s) based on specifics of application, such as process and type of food matrix. Although this disclosure substantially refers to brassica family vegetables, such teachings are equally applicable to other vegetables and foods with high Sulfur content.

In preferred embodiments, pieces of vegetable matter may be treated with a disclosed cation or cation blend by infusing vegetable pieces in a cation solution prior to drum drying or other heating process. Pieces of vegetable matter may alternatively be infused with cations during a blanching step or the like. In the canning context, a disclosed salt or solution thereof may be simply added to the canning brine prior to pasteurization. With respect to air dried vegetables or herbs, especially when used as ingredients in heat intensive applications such as baking, the disclosed salts can be, for example, included as an ingredient to be part of the ultimate product. In other embodiments, concentrates of juices, for example kale juice, disclosed salts may be simple added to the concentrates.

Brassica vegetables may be characterized by aromas of Sulfurous compounds from Glucosinolates and Sulfur containing amino acids among others. Thermal processing of these vegetables results in release of compounds such as Dimethyl Disulfide, Dimethyl Trisulfide, Hydrogen Sulfide, ammonia and pyridines. Dimethyl Trisulfide in particular has been associated with the aroma of cooked vegetables. It is believed that, at least because of such undesirable odors, brassica vegetables and other vegetables high in Sulfur compounds are rarely, if ever, commercially canned and sold.

Zinc and Copper may be used to improve the flavor (and odor) profile of purees of fresh and/or air-dried brassica vegetables, such those subjected to pasteurization, which may be understood as heating for at least 5 minutes at a temperature of at least 50° C. The strong affinity of minerals such as Zinc and Copper to Sulfur may result in reduction of formation of volatiles that are identified with processed vegetable aroma. The formation of Dimethyl Trisulfide during thermal processing of brassica compounds is known in the art to be mediated by Hydrogen Sulfide. Based on Zinc and Copper's ability to prevent or reduce the formation of Hydrogen Sulfide, it is believed that the formation of Dimethyl Trisulfide is minimized as well.

In preferred embodiments, a mineral blend composition for prevention of off-odors from brassica vegetable juices or other components may contain Copper Gluconate and Zinc Gluconate at a ratio ranging from 2:3 to 4:1. And, in preferred embodiments, application of such blend may be made at a concentration of 2 to 10 mg total cation per 2 g of dry vegetable. It is understood that although some minimal amount of water support may be needed to support the requisite chemical reactions, the various ratios of cations to each other and vegetable solids shall generally otherwise be unaffected by the amount of water.

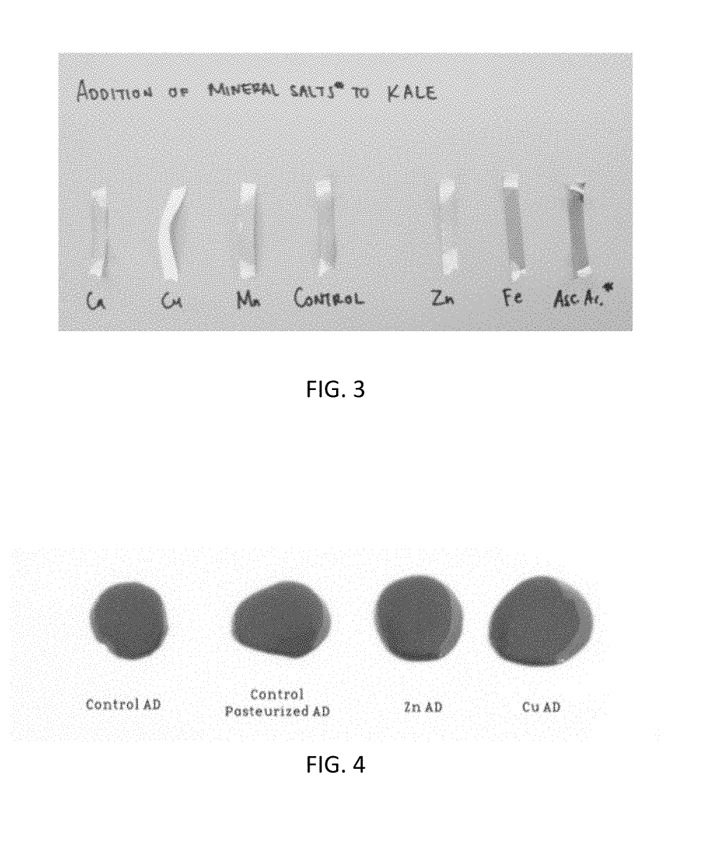

To test the effectiveness of various cations in reducing the formation of undesirable Sulfur compounds, mineral salts were added in a kale preparation (2 g of air dried kale powder+8 g of water) and heated at 95° C. for 30 min. These salts were tested at levels of 5 mg of cation for every 10 g of kale preparation. As a second control, 200 mg of ascorbic acid was added to one 10 g Kale preparation. As shown in FIG. 3, Lead Acetate test paper was used for detecting the amount of volatile Sulfur-containing compounds a visual comparison of Lead Acetate test papers for each sample. The test indicated that the Zinc and Copper cations caused reduced generation of volatile Sulfur-based compounds, such as Hydrogen Sulfide, when compared the addition of Mn++, Cu++, Fe++, Ca++, ascorbic acid, and the control. Particularly, the Copper salt (5 mg of Copper) seemed to be the most efficient avoiding Hydrogen Sulfide release during heating of kale preparation.

In addition to reducing the production of volatile Sulfur-containing compounds, application of the disclosed mineral blends and compositions may prevent or reverse discoloration of vegetable products resulting from the degradation of chlorophyll and the like. Pheophytin is a compound produced by degradation of chlorophyll during processing of vegetables, such as slicing, blanching, thermal sterilization, drying, and acidification. Processing green vegetables, in particular leafy vegetables, such as kale, with such techniques often results in a pale green-brown color that is considered undesirable. While previous work has been done on stabilizing the chlorophyll in canned vegetables using mineral salts in brine, there has not been any work done on restoration of green color in processed vegetables that have already undergone processing.

Consistent with the present disclosure, Zinc and Copper salts, such as Gluconates, may improve the color of dehydrated green vegetables, vegetable matter, and products that contain them. In preferred embodiments, a mineral blend composition for preventing discoloration or restoring color may contain Zinc and Copper at a ratio ranging from 4:1 to 2:3. And, in preferred embodiments, application of such blend may be made at a concentration of 2 to 10 mg total cation per 2 g of dry brassica vegetable.

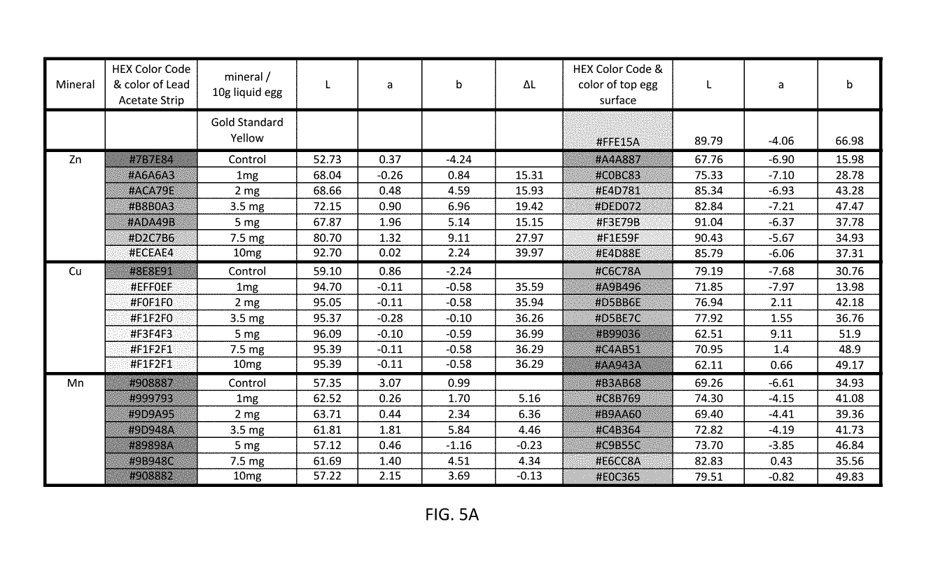

In an example of color restoration, as shown in FIG. 4, the color of air-dried vegetables has been restored back to bright green from pale, brownish green through use of disclosed cations. To test the effectiveness of Zinc and Copper in reducing the formation of undesirable Sulfur compounds, mineral salts were added in a Kale preparation (2 g of air dried kale powder+8 g of water) and heated at 95° C. for 30 min. During pasteurization, the color was restored in the samples treated with Zinc and Copper salts. It is believed that this color restoration resulted from the formation of Zinc and Copper complexes of Pheophytin and Pyropheophytin. Pasteurization or other heating after adding Zinc and/or Copper may be a requisite step for restoring or stabilizing a desirable green color.

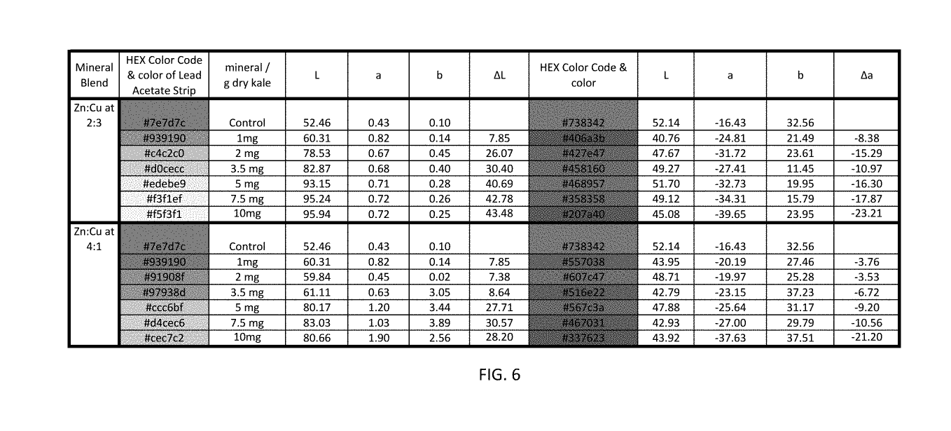

FIG. 6 depicts lab results showing measures of volatile Sulfur-containing compounds and color resulting from the inclusion of various amounts of mineral blends in a kale preparation. For each tested sample, 1 g of air-dried kale flakes and 9 g of water was mixed with the listed mineral blend in Gluconate salt form. The amount of mineral represents to the weight of mineral cations (in mg) included in each sample. For example, for each mg of Zinc, 6.97 mg of Zinc Gluconate was included; and for each mg of Copper, 7.14 mg of Copper Gluconate was included. Each preparation was heated at 95° C. for 30 min. Lead acetate strips were used in a manner substantially identical to that discussed above with respect to FIGS. 5A-5C to observe reductions in the release of volatile Sulfur-containing compounds. Again, ΔL is considered indicative of the effectiveness of each mineral blend addition on reducing undesired odors.

FIG. 6 also depicts the resulting color of kale preparation samples; such color is also described in the form of both HEX Color code and in CIELAB color coordinates. With respect to the observed final color of the samples, Δa in CIELAB coordinates, as calculated from the control strip (no mineral added) can be understood to reflect an improvement in the green color because a lower ‘a’ value indicates the color being closer to green and a higher ‘a’ value indicates the color being closer to red. Δa above −5 may be understood to indicate a lack of effective color improvement. Δa at or below −5 may be understood to indicate a minor color improvement. Δa at or below −10 may be understood to indicate a very effective color improvement. Δa at or above −15 may be understood to indicate an exceptionally effective color improvement.

It may be observed that the addition of at least 2 mg of a Zinc-Copper blend at a 2:3 ratio may result in an exceptional color improvement and an exceptional reduction in the release of volatile Sulfur-containing compounds.

In another example, air dried vegetables were also used as a major ingredient to impart color and flavor in a wheat based cracker. Addition of Zinc and Copper Gluconate at 0.1% of the total weight of the finished product improved the color of cracker by restoring the green color. Such technique may have also served to stabilize the green color, making it more heat resistant and permitting its maintenance during process of baking.

Ultimately, the presence of chlorophyll in green vegetables may counsel towards certain choices of metals in the mineral blend in order to take into account the binding of metal ions such as Copper and Zinc with chlorophyll and related compounds, such as its processed derivatives of Pheophytin and Pyropheophytin. For example, the binding of Zinc to Sulfurous compounds is negatively affected by the presence of chlorophyll and its derivatives. On the other hand, Copper is effective at neutralizing volatile Sulfurous compounds along with reverting the color of vegetables to green at the same concentration. For example, Copper is more effective than Zinc in kale, as shown by FIG. 4. It has also been observed Manganese salts have no significant effect on chlorophyll or chelation of Sulfur in processed vegetables.

Additionally, in different food preparations, higher concentrations of particular metal ions may be required for effectiveness. For example, while in certain food systems—such as liquid eggs—Zinc, Copper, and Manganese may all be viable for chelating Sulfurous compounds at relatively lower concentrations (See e.g., FIG. 1C, showing substantial effectiveness at 5 mg Zinc/10 g egg), the amount of Zinc and Manganese needed to chelate Sulfur may be higher in vegetable based food systems (See e.g., FIG. 4, showing only moderate effectiveness at 5 mg Zinc/2 g dried kale). It is believed that this variability between food matrices results from the presence of conflicting chemicals that can interact with metal ions. This counsels toward developing unique mineral blends for individual food preparations, consistent with the instant disclosure.

It may also be noted that the addition of ascorbic acid to vegetable preparations was observed to increase the generation of volatile Sulfurous compounds. It is believed that the propensity of Hydrogen Sulfide to exist in a gaseous state at acidic pH instead of a dissolved state (HS− ion) may case this. Thus, while ascorbic acid and other organic acids, such as citric acid, may be good chelators of Iron and, consequently, their use may help prevent formation of Ferrous Sulfide, the rotten egg odor will likely be higher compared to the use of mineral blends disclosed herein. Additionally, it is known in the art that sodium acid pyrophosphate may be used as a chelator of Iron. However, various studies note the bad flavor perception associated with added phosphates. Thus, the use of mineral blends disclosed herein may be superior than using sodium acid pyrophosphate.

Although the foregoing embodiments have been described in detail by way of illustration and example for purposes of clarity of understanding, it will be readily apparent to those of ordinary skill in the art in light of the description herein that certain changes and modifications may be made thereto without departing from the spirit or scope of the disclosure. It is also to be understood that the terminology used herein is for the purpose of describing particular aspects only, and is not intended to be limiting, since the scope of the present invention will be limited only by claims submitted in an application which claims priority to the instant application.

It is noted that, as used herein, the singular forms “a”, “an”, and “the” include plural referents unless the context clearly dictates otherwise. It is further noted that the claims in an application that claims priority to the instant disclosure may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of ordinary skill in the art upon reading this disclosure, each of the individual aspects described and illustrated herein has discrete components and features which may be readily separated from or combined with the features of any of the other several aspects without departing from the scope or spirit of the disclosure. Any recited method can be carried out in the order of events recited or in any other order that is logically possible. Accordingly, the preceding merely provides illustrative examples. It will be appreciated that those of ordinary skill in the art will be able to devise various arrangements which, although not explicitly described or shown herein, embody the principles of the disclosure and are included within its spirit and scope.

Furthermore, all examples and conditional language recited herein are principally intended to aid the reader in understanding the principles of the invention and the concepts contributed by the inventors to furthering the art, and are to be construed without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary configurations shown and described herein.

In this specification, various preferred embodiments have been described with reference to the accompanying drawings. It will be apparent, however, that various other modifications and changes may be made thereto and additional embodiments may be implemented without departing from the broader scope of this disclosure. The specification and drawings are accordingly to be regarded in an illustrative rather than restrictive sense.

We claim:

1. A method for creating a food product, comprising:
providing a portion of egg base, the egg base including water and egg solids;
providing a portion of cations, the cation portion including at least one of Zinc, Manganese, and Copper cations;
mixing the water, the egg solids, and the cation portion; and
heating the mixture.

2. The method of claim 1, wherein the step of providing a portion of cations further comprises:
providing between 0.25 and 10 mg of cations per quantity of egg base having Sulfur content equivalent to that of 10 g of whole liquid egg.

3. The method of claim 2, wherein the step of providing a portion of cations further comprises:
providing a mineral blend comprising at least two of Zinc, Manganese, and Copper cations at between 1 and 10 mg of total cations per quantity of egg base having Sulfur content equivalent to that of 10 g of whole liquid egg.

4. The method of claim 1, wherein the step of providing a portion of cations further comprises:
providing between 0.25 mg and 1 mg of Copper cations per quantity of egg base having Sulfur content equivalent to that of 10 g of whole liquid egg.

5. The method of claim 4, wherein the step of providing Copper cations further comprises:
providing Copper Gluconate containing a corresponding amount of Copper.

4. The method of claim 1, wherein the step of providing a portion of cations further comprises:
providing between 0.25 mg and 2 mg of Copper cations per quantity of egg base having Sulfur content equivalent to that of 10 g of whole liquid egg.

6. The method of claim 4, wherein the step of providing Copper cations further comprises:
providing Copper Gluconate containing a corresponding amount of Copper cations.

7. The method of claim 3, wherein the step of providing a portion of cations further comprises:
providing a total of between 3 mg and 10 mg of Zinc and Manganese cations with a relative ratio of Zinc cations to Manganese cations of between 1:1 and 4:1 per quantity of egg base having Sulfur content equivalent to that of 10 g of whole liquid egg.

8. The method of claim 7, wherein the step of providing Zinc and Manganese cations further comprises:
providing Zinc Gluconate containing a corresponding amount of Zinc cations and Manganese Gluconate containing a corresponding amount of Manganese cations.

9. The method of claim 7, wherein the step of providing Zinc and Manganese cations further comprises:
providing less than 2 mg of Manganese cations per quantity of egg base having Sulfur content equivalent to that of 10 g of whole liquid egg.

10. The method of claim 9, wherein the step of providing Zinc and Manganese cations further comprises:
providing Zinc Gluconate containing a corresponding amount of Zinc cations and Manganese Gluconate containing a corresponding amount of Manganese cations.

11. The method of claim 1, wherein the step of providing a portion of cations further comprises:
providing between 1 mg and 10 mg of Zinc cations per quantity of egg base having Sulfur content equivalent to that of 10 g of whole liquid egg.

12. The method of claim 11, wherein the step of providing Zinc cations further comprises:
providing Zinc Gluconate containing a corresponding amount of Zinc cations.

13. The method of claim 1, wherein the step of providing a portion of cations further comprises:
providing between 1 mg and 5 mg of Zinc cations per quantity of egg base having Sulfur content equivalent to that of 10 g of whole liquid egg.

14. The method of claim 1, wherein the step of heating the mixture further comprises:
heating the mixture for at least ten minutes at a temperature of at least 50° C.

15. The method of claim 1, wherein the step of providing a portion of cations further comprises:
providing at least one of Zinc Gluconate, Manganese Gluconate, and Copper Gluconate.

16. A food product, comprising:
cooked egg; and
Sulfur-containing salts of at least one of Zinc, Manganese, and Copper,
wherein:
the food product contains between 0.25 and 10 mg of metal components of the Sulfur-containing salts per 0.967 g egg white solids and between 0.25 and 10 mg of metal components of the Sulfur-containing salts per 5.35 g egg yolk solids.

17. The food product of claim 16, wherein:
the Sulfur-containing salts include Zinc Sulfide; and
the food product contains between 1 and 10 mg of Zinc per 0.967 g egg white solids and between 1 and 10 mg of Zinc per 5.35 g egg yolk solids

18. The food product of claim 16, wherein:
the Sulfur-containing salts include Copper Sulfide and Copper Sulfate; and
the food product contains between 0.25 and 2 mg of Copper per 0.967 g egg white solids and between 0.25 and 2 mg of Copper per 5.35 g egg yolk solids

19. The food product of claim 16, wherein:
the cooked egg comprises cooked egg yolk; and
the food product does not have a green-grey appearance.

20. A food product prepared by a process comprising the steps of:
providing a portion of egg base, the egg base including water and egg solids;
providing a portion of cations, the cation portion including at least one of Zinc, Manganese, and Copper cations;
mixing the water, the egg solids, and the cation portion; and
heating the mixture.
